(19) United States
(12) Patent Application Publication
(10) Pub. No.: US 2020/0107265 A1
(43) Pub. Date: Apr. 2, 2020

(54) UE Power Consumption Characteristics and Adaptation to Traffic

(71) Applicant: MEDIATEK INC., Hsin-Chu (TW)

(72) Inventors: Chien-Hwa Hwang, Hsin-Chu (TW); Cheng-Hsun Li, Hsin-Chu (TW); Yiju Liao, Hsin-Chu (TW); Xiu-Sheng Li, Hsin-Chu (TW); Wei-De Wu, Hsin-Chu (TW); Chi-Hsuan Hsieh, Hsin-Chu (TW)

(21) Appl. No.: 16/580,255

(22) Filed: Sep. 24, 2019

Related U.S. Application Data
(60) Provisional application No. 62/738,057, filed on Sep. 28, 2018.
(60) Provisional application No. 62/747,713, filed on Oct. 19, 2018.
(60) Provisional application No. 62/754,700, filed on Nov. 2, 2018.

(51) Int. Cl. H04W 52/02; H04W 72/04; H04W 72/14; H04W 72/12

(52) U.S. Cl. CPC H04W 52/0229; H04W 72/048; H04W 52/0216; H04W 72/1284; H04W 72/14

(57) ABSTRACT

A method of UE adaptation to traffic and UE power consumption characteristics based on power profile is proposed. A power profile comprises a set of restrictions on range of values of a subset of RRC parameters that are power consumption relevant. Each power profile targets for a particular traffic characteristic. Further, UE parameter adaptation can be triggered with the help of UE assistance information, e.g., the index of the power profile best fits the operation condition. In one preferred embodiment, hybrid of bandwidth part (BWP) and power profile is proposed. UE is configured with multiple BWPs and each BWP includes a set of power profiles. Within a BWP, only one of the power profiles is active at a time; the parameter configuration of each power profile corresponds to a specific traffic characteristic.

### CROSS REFERENCE TO RELATED APPLICATIONS

This application claims priority under 35 U.S.C. § 119 from U.S. Provisional Application No. 62/738,057, entitled “UE Adaptation to the Traffic and UE Power Consumption Characteristics” filed on Sep. 28, 2018; from U.S. Provisional Application No. 62/747,713, entitled “UE Adaptation to Traffic and Power Consumption Characteristics” filed on Oct. 19, 2018; and from U.S. Provisional Application No. 62/754,700, entitled “Adaptation Framework for UE Power Saving” filed on Nov. 2, 2018, the subject matter of each of the foregoing references is incorporated herein by reference.

### TECHNICAL FIELD

The disclosed embodiments relate to wireless communication networks, and more specifically, to UE adaptation to traffic for UE power saving based on UE power consumption characteristics in next generation 5G new radio (NR) mobile communication networks.

### BACKGROUND

A Long-Term Evolution (LTE) system offers high peak data rates, low latency, improved system capacity, and low operating cost resulting from simple network architecture. An LTE system also provides seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred as user equipments (UEs). Enhancements to LTE systems are considered so that they can meet or exceed International Mobile Telecommunications Advanced (IMT-Advanced) fourth generation (4G) standard.

The signal bandwidth for next generation 5G new radio (NR) systems is estimated to increase to up to hundreds of MHz for below 6 GHz bands and even to values of GHz in case of millimeter wave bands. Furthermore, the NR peak rate requirement can be up to 20 Gbps, which is more than ten times of LTE. Three main applications in 5G NR system include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported.

In LTE and NR networks, Physical Downlink Control Channel (PDCCH) is used for dynamic scheduling. A plurality of physical resource blocks (PRBs) is allocated for PDCCH transmission that carry downlink control information (DCI). UE needs to monitor common search spaces and UE-specific search spaces for decoding PDCCH. In addition, UE needs to periodically measure the received signal quality of the serving cell and neighbor cells and reports the measurement result to its serving eNB for potential handover or cell reselection. To save power, Discontinuous Reception (DRX) needs to be applied in both Idle mode and Connected mode, with short awake times and long sleep cycles.

The study for NR UE power saving is started with identifying the use cases which power saving is essential. The different use cases may include: PDCCH only, low throughput, and high throughput. When comparing of NR and LTE power consumption, a first observation is that NR has much higher power consumption than LTE particularly at PDCCH only and low throughput. However, at high throughput, NR is relatively power efficient compared with LTE. For example, NR provides more than twice throughput of LTE with only 1.15 times power consumption.

Power consumption is a function of many factors, such as power amplifier (PA) efficiency, number of RF modules and baseband paths in circuits, active transmission/reception time, sleep mode duration, channel bandwidth, receiver processing latency/complexity, and so on. Some factors such as PA efficiency and receiver processing are implementation specific, while some others (e.g., sleep mode duration, channel bandwidth, etc.) may depend on network configuration. If these power relevant parameters are configured appropriately, power saving can be achieved without incurring undesirable side effects such as latency increase or throughput loss. The question is the interplay between network configuration and the quality of service of traffic. It has been observed that NR UE PHY setting adaptation with respect to traffic is helpful for UE power saving.

In multiuser wireless communication systems including NR, multiple access techniques are used to allow a large number of mobile users to share the spectrum in the most efficient manner. The sharing can be performed in the domains of time, frequency, space, etc. All UEs take turns to be served, and each particular UE is active only in part of the time, the system bandwidth, and the directions of signal arrival/departure, although allocated percentage of resource depends on the quality of service of the ongoing traffic. Obviously, it is wasteful in battery energy if a UE keeps alive in a domain which it can never be served. Thus, from the perspective of domains of multiple access, it is straightforward to see parameters relevant to time, frequency and space can be configured based on the traffic types for the purpose of power saving.

Solutions for NR UE power saving with UE adaptation based on traffic and UE power consumption characteristics are sought.

### SUMMARY

A method of UE adaptation to traffic and UE power consumption characteristics based on power profile is proposed. A power profile comprises a set of restrictions on range of values of a subset of RRC parameters that are power consumption relevant. Each power profile targets for a particular traffic characteristic. Further, UE parameter adaptation can be triggered with the help of UE assistance information, e.g., the index of the power profile best fits the operation condition. In one preferred embodiment, hybrid of bandwidth part (BWP) and power profile is proposed. UE is configured with multiple BWPs and each BWP includes a set of power profiles. Within a BWP, only one of the power profiles is active at a time; the parameter configuration of each power profile corresponds to a specific traffic characteristic.

In one embodiment, a UE receives a power profile configuration from a base station in a mobile communication network. The power profile configuration comprises a list of power profiles, and each power profile comprises a subset of power-related parameters, and each of the power-related parameters corresponds to a restricted range of values. The UE monitors a physical downlink control channel (PDCCH) and decodes a power profile switch command. The UE applies a selected power profile based on the power profile switch command.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a next generation new radio (NR) mobile communication network with user equipment (UE) parameter adaptation using power profiles for power saving in accordance with one novel aspect.

FIG. 2 illustrates simplified block diagrams of a base station and a user equipment in accordance with embodiments of the present invention.

FIG. 3 illustrates one embodiment of UE power profile configuration adapted to different traffic profiles in accordance with one novel aspect.

FIG. 4 illustrates one embodiment of UE profile based on bandwidth part (BWP) framework in accordance with one novel aspect.

FIG. 5 illustrates one embodiment of UE profile configuration within each bandwidth part (BWP) in accordance with one novel aspect.

FIG. 6 illustrates a UE state machine and mechanism of UE power profile adaptation trigger in accordance with one novel aspect.

FIG. 7 illustrates a flow chart of a method of UE power profile configuration and adaptation for UE power saving in accordance with embodiments of the present invention.

### DETAILED DESCRIPTION

Reference will now be made in detail to some embodiments of the invention, examples of which are illustrated in the accompanying drawings.

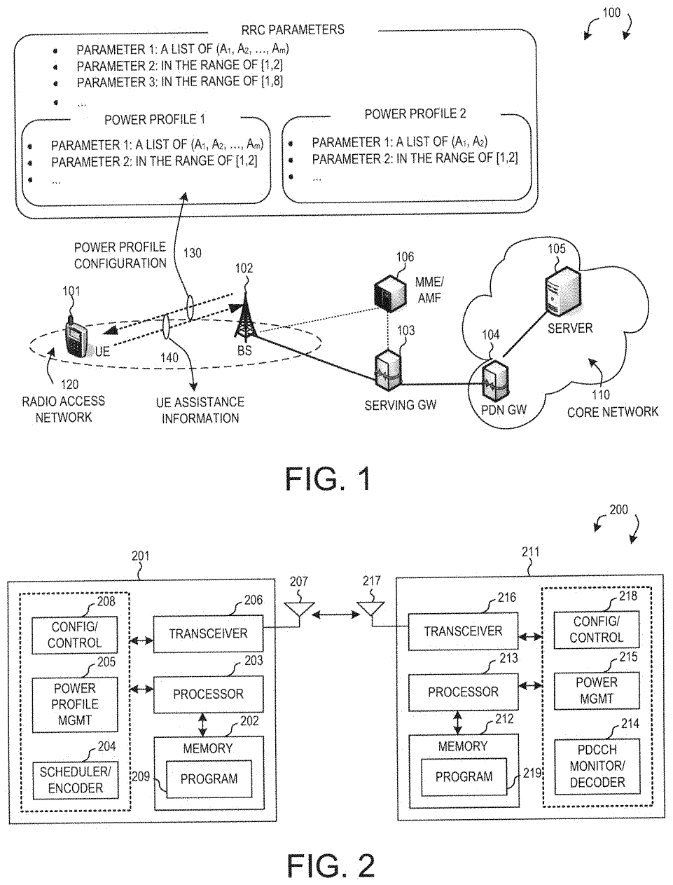

FIG. 1 illustrates a next generation new radio (NR) mobile communication network 100 with user equipment (UE) parameter adaptation using power profiles for power saving in accordance with one novel aspect. LTE/NR network 100 comprises application server 105 that provides various services by communicating with a plurality of user equipments (UEs) including UE 101. In the example of FIG. 1, application server 105 and a packet data network gateway (PDN GW or P-GW) 104 belong to part of a core network CN 110. UE 101 and its serving base station BS 102 belong to part of a radio access network RAN 120. RAN 120 provides radio access for UE 101 via a radio access technology (RAT). Application server 105 communicates with UE 101 through PDN GW 104, serving GW 103, and BS 102. A mobility management entity (MME) or an access and mobility management function (AMF) 117 communicates with BS 102, serving GW 103 and PDN GW 104 for access and mobility management of wireless access devices in LTE/NR network 100. UE 101 may be equipped with a radio frequency (RF) transceiver or multiple RF transceivers for different application services via different RATs/CNs. UE 101 may be a smart phone, a wearable device, an Internet of Things (IoT) device, and a tablet, etc.

When there is a downlink packet to be sent from the BS to the UE, each UE gets a downlink assignment, e.g., a set of radio resources in a physical downlink shared channel (PDSCH). When a UE needs to send a packet to the BS in the uplink, the UE gets a grant from the BS that assigns a physical uplink shared channel (PUSCH) consisting of a set of uplink radio resources. The UE gets the downlink or uplink scheduling information from an NR-PDCCH that is targeted specifically to that UE. In addition, broadcast control information is also sent in the NR-PDCCH to all UEs in a cell. The downlink and uplink scheduling information and the broadcast control information, carried by the NR-PDCCH, together is referred to as downlink control information (DCI).

UE power consumption is a function of many factors, such as power amplifier (PA) efficiency, number of RF modules and baseband paths in circuits, active transmission and reception time, sleep mode duration, channel bandwidth, receiver processing latency and complexity, and so on. Some factors such as PA efficiency and receiver processing are implementation specific, while some other factors (e.g., sleep mode duration, channel bandwidth, etc.) may depend on network configuration. If these power-relevant parameters are configured appropriately, power saving can be achieved without incurring undesirable side effects such as latency increase or throughput loss. The question is the interplay between network configuration and the quality of service of traffic. It has been observed that NR UE PHY setting adaptation with respect to traffic is helpful for UE power saving.

In multiuser wireless communication systems including NR, multiple access techniques are used to allow a large number of mobile users to share the spectrum in the most efficient manner. Thus, from the perspective of domains of multiple access, it is straightforward to see parameters relevant to time, frequency and space can be configured based on the traffic types for the purpose of power saving. For example, discontinuous reception (DRX) configuration and PDCCH monitoring periodicity are time-domain parameters to be considered for UE power saving; the bandwidth of BWPs is a frequency-domain parameter to be considered for UE power saving; the number of RX antennas is a spatial-domain parameters to be considered for UE power saving; cross slot scheduling can be considered for UE power saving. In addition, it is expected that UE parameter adaptation is helpful to UE energy consumption, and UE can realize better power consumption in NR than in LTE if PHY setting adaptation is applied.

In accordance with one novel aspect, the concept of power profile is introduced. A power profile comprises a set of restrictions on the indicated values of RRC parameters that are power consumption relevant. Each power profile targets for a particular traffic characteristic. More specifically, for each power profile, a set of power-related parameters are configured to best fit the operation condition such as traffic characteristic the power profile is targeted for. Further, UE parameter adaptation can be triggered with the help of UE assistance information, e.g., the index of the power profile best fits the operation condition. As depicted by 130, Parameter 1, Parameter 2, Parameter 3, etc. are a set of higher layer parameters. In power profiles, indicated values of some parameters are restricted to a smaller range. For instance, in power profile 1, the range of Parameter 2 is restricted to [1, 2], a subset of the original range [1, 8]. The motivation for power profile is achieving power saving by means of limiting the ranges of indicated values. For instance, if the processing time K₀ is always larger than 0 (i.e., cross-slot scheduling is used all the time), the UE can reduce the clock rate in processing PDCCH and reduces power consumption accordingly.

In the example of FIG. 1, UE 101 is configured by the network with a set of power profiles. UE 101 may be configured with a list of parameters via RRC signaling, and each parameter is defined with a range of values. Among the RRC configured parameters, a subset of the parameters is related to power saving, e.g., power consumption relevant. A power profile comprises a combination of restrictions on the range of defined values of the subset of parameters that are power consumption relevant. As depicted by 130, power profile #1 is defined to best fit a first operation condition, while power profile #2 is defined to best fit a second operation condition. Based on UE operation condition, UE 101 can be configured with power profile #1 or power profile #2. As depicted by 140, UE 101 may also provide assistance information to the network, e.g., which power profile the UE prefers, to assist the network to make the best decision of power profile adaptation for UE power saving.

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out embodiments of the present invention. The different functional modules and circuits can be implemented by software, firmware, hardware, or any combination thereof. In one example, each function module or circuit comprises a processor together with corresponding program codes. The function modules and circuits, when executed by the processors 203 and 213 (e.g., via executing program codes 209 and 219), for example, allow base station 201 to config power profiles for UE 211 and transmit downlink control information to UE 211 for power profile adaptation, and allow UE 211 to receive and decode the downlink control information and perform power profile adaptation to traffic and power consumption characteristics.

In one embodiment, base station 201 provides power profile configuration to UE 211 via configuration and control circuit 208, provides power profile switch command to UE 211 via power profile management circuit 205 for power profile adaptation, and schedules and encodes data transmission via scheduler/encoder 204. UE 211 receives power profile configuration from BS 201 via configuration and control circuit 218, performs power profile management via power management circuit 215, and monitors PDCCH and decodes DCI and other signaling including a wakeup signal (WUS) carrying power profile switch command via PDCCH monitor and decoder 214.

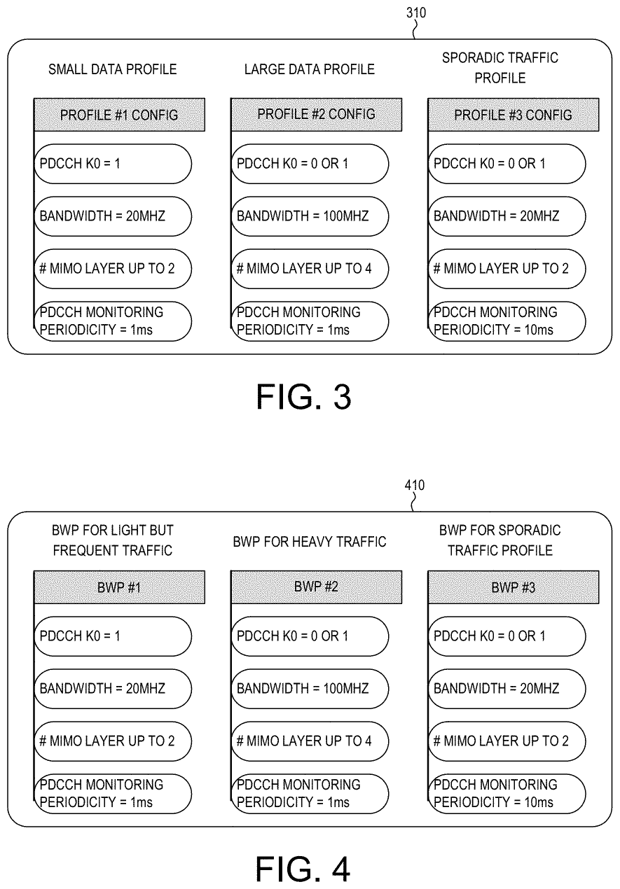

FIG. 3 illustrates one embodiment of UE power profile configuration adapted to different traffic profiles in accordance with one novel aspect. It has been observed that NR UE PHY setting adaptation with respect to traffic is helpful for UE power saving. From multiple access perspective, parameters relevant to time, frequency, and space can be configured based on the traffic types for the purpose of power saving. First, parameters in time domain are critical in power savings as energy consumption scales linearly with the time duration. DRX brings power saving at the cost of increased latency. PDCCH monitoring periodicity is also useful in energy saving. Thus, DRX parameters and PDCCH monitoring periodicity are time-domain parameters to be considered for UE power saving. Second, in frequency domain, the BWP concept is introduced in NR in order to reduce power consumption of NR devices. The desirable UE behavior is being active on wide bandwidth in bursty traffic situation for short time period, while being active on narrow bandwidth for rest of the time duration. This is known as bandwidth adaptation. The bandwidth of BWP is a frequency-domain parameter to be considered for UE power saving. Third, in spatial domain, the number of UE receive antenna is an important parameter. Although beneficial during data reception, the use of four receive antennas comes at a cost in terms of increased power consumption. An increased number of receive antennas, generally results in higher data rates, implying shorter reception time. This, in turn, all other things being equal, translates into lower power consumption. However, in low data rate or non-active mode, power consumption cost may persist without the reception benefits. For this reason, a decision in network configuration regarding whether to use all four antennas or to reduce to a smaller set, depending on the present situation, in order to preserve power.

Besides the perspective of multiple access, candidate parameters for power saving adaptation can be identified from other consideration. Cross-slot scheduling (i.e., K₀>0) in the downlink with nonzero K₀ presents significant opportunities for power saving in the UE. The value K₀ here indicates a time duration (e.g., the number of slots) between the scheduling PDCCH and the scheduled data. A large component of power consumption arises if in each slot, downlink data must be captured assuming the maximum throughput configuration for the entire duration of PDCCH decoding, in case some of the captured data is represented in a downlink allocation which may or may not be present. In general, less energy is required to capture and decode PDCCH than to decode PDSCH, because typically a smaller set of resource blocks is involved, lower order modulation is used and there can be a significant reduction in the bandwidth of interest. This can mean that fewer modem resources are needed for a PDCCH-only decode, leading to reductions in UE power consumption during the decoding process. Consequently, if a UE can know in advance that it need not decode PDSCH in the current slot, it only needs to enable sufficient DL resources to receive and decode PDCCH, and can disable the receiving resources as soon as the PDCCH symbols have been captured.

It is observed that adapting the parameter configuration is quite useful for NR UE power saving. Specifically, using WeChat as an example, the configuration from (100 MHz, 4 RX, K₀=0) to (20 MHz, 4 RX, K₀=0) can reduce the power by 37%; configuration from (20 MHz, 4 RX, K₀=0) to (20 MHz, 2 RX, K₀=0) can reduce 14% power; and further reduction of 13% can be achieved if K₀ is increased to 1. We can see when (20 MHz, 2 RX, K₀=1) configuration is used in NR for WeChat, it is more power efficient than LTE. Therefore, based on the measured time percentage of power states for WeChat, it is expected UE parameter adaptation is helpful to UE energy consumption.

In the example of FIG. 3, a UE is configured with three different power profiles. As discussed above, UE power consumption is highly relevant to parameters in frequency, time, space domains, and so on. For a given traffic, if the parameters can be configured appropriately, UE power saving can be achieved without sacrificing throughput and latency. As depicted by Table 310, there are 3 profiles for different traffic characteristics, including one for small data, one for large data, and the other for sporadic traffic. Each profile comprises a set of parameters with the values configured to best fit the traffic characteristics for which the profile is targeted. For example, profile #1 is configured for small data profile, with small bandwidth and small MIMO layer, with cross-slot scheduling; profile #2 is configured for large data profile, with large bandwidth and large MIMO layer, with or without cross-slot scheduling. When the data comes in a sporadic way, the energy is wasted if the UE monitors PDCCH in every slot of active state in Connected-mode-DRX. In this case, profile #3 is configured with longer PDCCH monitoring periodicity (10 ms) for UE to reduce the energy consumption in PDCCH-only state.

When it comes to the configuration of adapted parameters, it is important to examine the relative energy contributions of different components to the average power consumption. In so doing, it is possible to prioritize different power saving configuration, which leads to recommendations on how these parameters can be configured to give good UE power consumption while avoiding unnecessary constraints on network flexibility. It is observed that reduction of bandwidth leads to substantial reductions in UE energy consumption. Therefore, it is natural to consider the UE power profile configuration method based on the framework of BWP. A BWP consists of a continuous range of physical resource blocks (PRB) in frequency domain and whose occupied bandwidth is the subset of the bandwidth of the associated carrier. For each UE, there is at most one active downlink (DL) BWP and at most one active uplink (UL) BWP at a given time for a serving cell. As a result, power consumption is reduced because UE is only required to monitoring the smaller frequency range of the active BWP.

FIG. 4 illustrates one embodiment of UE profile based on bandwidth part (BWP) framework in accordance with one novel aspect. One of the motivations for BWP is UE power saving by bandwidth adaptation based on the traffic characteristic. Additional power consumption relevant parameters can be incorporated in BWP configuration as well, and UE power saving can be achieved by adapting more power-related parameter configurations in different domains besides the bandwidth. In the example of FIG. 4, a UE is configured with three BWPs (BWP#1, BWP#2, and BWP#3) for the purpose of serving light-but-frequent traffic, heavy traffic, and sporadic traffic, respectively. As depicted by Table 410, the indicated values of parameters in each BWP are chosen in a power efficient manner so that under the associated traffic characteristic, the performance metrics of throughput, latency, etc., are not degraded. When the traffic characteristic for a UE changes, the network issues a command to the UE to perform BWP switching.

However, shortcomings of power consumption configuration solely based on BWP framework still need to be identified. For example, flexibility in adaptation is limited if the number of configured BWPs is not large. For example, when a UE is configured with 2 BWPs, there are only 2 configurations for power saving. Taking into account all identified power consumption relevant parameters, the flexibility in power consumption configuration in serving different traffic types solely based on BWP is insufficient. Moreover, long transition time of BWP switching may lead to inefficient operation when adaptation is frequent. Even with dynamic BWP switching, the transition time can be as long as 3 ms, during which the UE cannot transmit and receive. This consideration will certainly decrease network's intention in issuing an adaptation command. Lastly, adaptation for parameters which are non-BWP specific needs extra handling. Besides, since configuration of BWP comprises BWP-Uplink and BWP-Downlink, parameters which are non-link-direction specific also need additional handling.

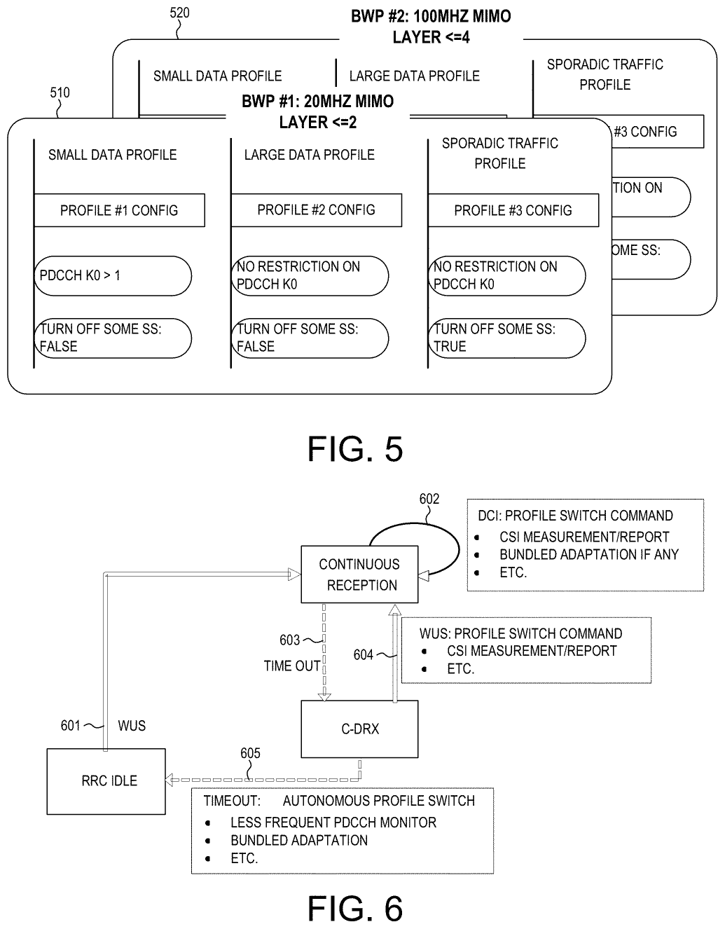

FIG. 5 illustrates one embodiment of UE profile configuration within each bandwidth part (BWP) in accordance with one novel aspect. Due to the drawbacks of power consumption configuration based on BWP, a configuration method based on hybrid of BWP and power profile is proposed. A UE is configured with multiple BWPs in a serving cell, and each BWP includes a set of power profiles. Within a BWP, only one of the power profiles is active at a time; the parameter configuration of each power profile corresponds to a specific traffic characteristic. In the example of FIG. 5, the UE is configured with two BWPs, BWP#1 has 20 MHx bandwidth and BWP#2 has 100 MHz bandwidth. Within each BWP, three power profiles are configured: one power profile is for small data traffic, another for large data traffic, and the other for sporadic traffic profile.

In order to reduce the transition time of UE adaptation, the adapted parameters can be partitioned into two categories. One category is for those parameters with long transition time, and the other category is for those parameters without long transition time. A simple example of categorization is RF relevant parameters, including retuning the local oscillator, reconfiguring the RF chain for more or less bandwidth, etc., and baseband processing relevant parameters, for which a short switching time is expected. For example, in FIG. 5, the bandwidth and the maximum number of MIMO layers are RF parameters, so they are configured in BWP. Search space configurations and K₀ are considered as baseband parameters, and their range can be restricted in power profiles. In so doing, different transition time for RF relevant parameters and for baseband parameters can be separately defined, and the transition time for adaptation involved with only baseband parameters can be reduced.

FIG. 6 illustrates a UE state machine and mechanism of UE power profile adaptation trigger in accordance with one novel aspect. When a UE connects to the network, the UE is configured with multiple BWPs and each BWP is configured with a set of PHY power profiles. Each PHY power profile corresponds to restricted ranges of configured values for power-related parameters. Later on, switching among different PHY power profiles of BWPs can be indicated from the network to the UE by RRC, MAC CE, or DCI signaling, or autonomously performed by the UE. The UE is initially in RRC idle mode and the associated power profile for idle mode is also configured. In step 601, the UE receives a paging PDCCH from the network and the UE goes to RRC connected mode with continuous reception. In one novel aspect, the UE also receives a wakeup signal (WUS), which either is embedded in the paging signal or is a separate signal, which indicates a power profile to be applied for continuous reception.

In step 602, during the continuous reception mode, the UE monitors PDCCH for DCI (e.g., in every slot). UE also performs CSI measurements and reporting, bundled adaptation if any, etc. Upon receiving power profile switching command (e.g., via the DCI), UE may adapt to a different power profile to save power. If UE has no activity for a while and is timed out, then in step 603, UE goes to connected mode DRX (C-DRX) mode with discontinuous reception. In one novel aspect, there is a timer to trigger UE power adaptation. When the timer for the active power profile expires, the UE may autonomously switch to a default power profile. In step 604, from C-DRX mode, UE may go back to continuous reception mode upon receiving a data scheduling PDCCH. In addition, a power profile switching command (e.g., via WUS), can be embedded in the PDCCH or can be another separate signal sent to the UE, indicates a power profile to be applied for continuous reception. In step 605, from C-DRX mode, UE may also go back to RRC idle mode if UE has no activity for a while and is timed out. Again, UE may autonomously switch to a default power profile when the timer for the active power profile expires. Note that UE may provide assistance information (e.g., the index of the preferred power profile) to the network for power profile selection. For example, the assistance information can be embedded in the buffer status report (BSR) that suggests to the network which power profile best suites the upcoming uplink data traffic profile.

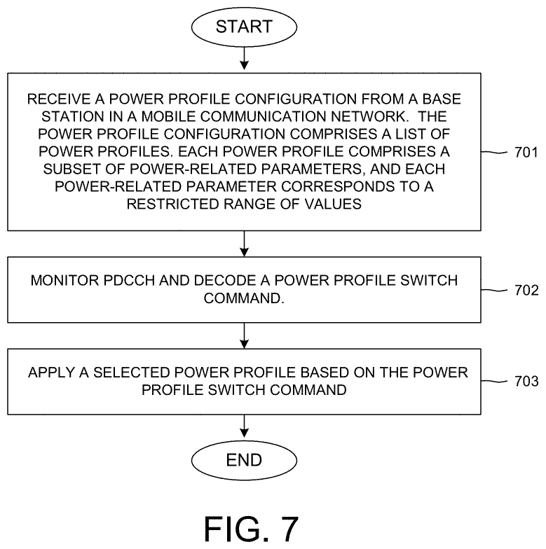

FIG. 7 illustrates a flow chart of a method of UE power profile configuration and adaptation for UE power saving in accordance with embodiments of the present invention. In step 701, a UE receives a power profile configuration from a base station in a mobile communication network. The power profile configuration comprises a list of power profiles, and each power profile comprises a subset of power-related parameters, and each of the power-related parameters corresponds to a restricted range of values. In step 702, the UE monitors a physical downlink control channel (PDCCH) and decodes a power profile switch command. In step 703, the UE applies a selected power profile based on the power profile switch command.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a power profile configuration from a base station by a User Equipment (UE) in a mobile communication network, wherein the power profile configuration comprises a list of power profiles, wherein each power profile comprises a subset of power-related parameters, and wherein each of the power-related parameters corresponds to a restricted range of values;
monitoring a physical downlink control channel (PDCCH) and decoding a power profile switch command; and
applying a selected power profile based on the power profile switch command.

2. The method of claim 1, wherein the subset of power-related parameters belongs to a set of radio resource control (RRC) configured parameters configured with a full range of values.

3. The method of claim 1, wherein the subset of power-related parameters comprises a bandwidth, a time duration between the PDCCH and corresponding scheduled data, a PDCCH monitor periodicity, and a number of MIMO layers.

4. The method of claim 1, wherein different power profiles are configured to be applied for different traffic profiles comprising small data profile, large data profile, and sporadic data profile.

5. The method of claim 1, wherein the UE dynamically adapts to different traffic profiles by applying a corresponding power profile.

6. The method of claim 1, wherein the UE is configured with multiple bandwidth parts (BWPs) in a carrier bandwidth, wherein each BWP is associated with a power profile.

7. The method of claim 6, wherein the UE is configured with multiple bandwidth parts (BWPs) in a carrier bandwidth, wherein each BWP is configured with multiple power profiles.

8. The method of claim 1, further comprising:
transmitting UE assistance information to the network, wherein the UE assistance information comprises an index to a preferred power profile.

9. The method of claim 1, wherein the power profile switch command is carried by a wakeup signal that either is a separate signal or is embedded within the PDCCH.

10. The method of claim 1, wherein each power profile is associated with a timer, and wherein the UE switches to a default power profile when the timer expires.

11. A User Equipment comprising:
a receiver that receives a power profile configuration from a base station in a mobile communication network, wherein the power profile configuration comprises a list of power profiles, wherein each power profile comprises a subset of power-related parameters, and wherein each of the power-related parameters corresponds to a restricted range of values;
a decoder that monitors a physical downlink control channel (PDCCH) and decodes a power profile switch command; and
a power management circuit that applies a selected power profile based on the power profile switch command.

12. The UE of claim 11, wherein the subset of power-related parameters belongs to a set of RRC configured parameters configured with a full range of values.

13. The UE of claim 11, wherein the subset of power-related parameters comprises a bandwidth, a time duration between the PDCCH and corresponding scheduled data, a PDCCH monitor periodicity, and a number of MIMO layers.

14. The UE of claim 11, wherein different power profiles are configured to be applied for different traffic profiles comprising small data profile, large data profile, and sporadic data profile.

15. The UE of claim 11, wherein the UE dynamically adapts to different traffic profiles by applying a corresponding power profile.

16. The UE of claim 11, wherein the UE is configured with multiple bandwidth parts (BWPs) in a carrier bandwidth, wherein each BWP is associated with a power profile.

17. The UE of claim 16, wherein the UE is configured with multiple bandwidth parts (BWPs) in a carrier bandwidth, wherein each BWP is configured with multiple power profiles.

18. The UE of claim 11, further comprising:
a transmitter that transmits UE assistance information to the network, wherein the UE assistance information comprises an index to a preferred power profile.

19. The UE of claim 11, wherein the power profile switch command is carried by a wakeup signal that either is a separate signal or is embedded within the PDCCH.

20. The UE of claim 11, wherein each power profile is associated with a timer, and wherein the UE switches to a default power profile when the timer expires.
